(19) United States
(12) Patent Application Publication
(10) Pub. No.: US 2023/0196972 A1
(43) Pub. Date: Jun. 22, 2023

(54) MULTI-ANGLE ATTACHABLE DISPLAY DEVICE AND SYSTEM THEREOF

(71) Applicant: Peng Hsiang Lai, New Taipei City (TW)

(72) Inventor: Peng Hsiang Lai, New Taipei City (TW)

(21) Appl. No.: 17/557,275

(22) Filed: Dec. 21, 2021

(51) Int. Cl. G09G 3/20; G09F 9/302; G09G 3/32

(52) U.S. Cl. CPC G09G 3/2096; G09F 9/3026; G09G 3/32; G09F 9/3023; G09G 2300/026; G09G 2370/16; G09G 2370/22; G09G 2360/04

(57) ABSTRACT

A multi-angle attachable display device includes a polygonal light emitting module and a control module. The light emitting module has a light emitting layer with at least one light emitting unit, a module driver, and multiple connection ports. The at least one light emitting unit includes a unit driver that electrically connects the module driver. Each of the connection ports is mounted on a side surface of the light emitting layer and electrically connected to the module driver. The control module includes a controller connection port, a wireless communication unit, and a processing unit. When the controller connection port is connected to one of the connection ports of the light emitting layer, the processing unit detects a connection pathway of the light emitting module, and the processing unit generates and sends a light pattern signal to control the unit driver through the controller connection port and the module driver.

### BACKGROUND OF THE INVENTION

### 1. Field of the Invention

The present invention relates to a multi-angle display device and system thereof, more particularly a multi-angle attachable display device and system thereof.

### 2. Description of the Related Art

As a city develops, art installations tend to be replaced by light panels. Light panels are widely used for dynamically changing light patterns to a wide range of audience. For displaying light patterns to a small group, video panels of a small-group size are used, and vise versa. These light panels are able to connect with each other, such that arrays of light panels can function as a whole, forming an adjustable overall screen of light patterns.

However, such light panels nowadays still have some drawbacks. One of the drawbacks is that for most of the light panels, each one of the light panels lacks an ability to display different colors individually. In other words, even if a single light panel has multi-colored light-emitting diodes (LEDs), the single light panel lacks an ability to recognize relative positions of different color LEDs on the single light panel as the single light panel is only equipped with a basic control chip. The basic control chip only controls individual lights connected in series. As a result, the light panels are only able to display basic light patterns, rather than display videos.

Another drawback is that even if the light panels are able to display videos and function as video panels, these light panels still lack a degree of freedom to be freely and interchangeably connected with each other. In other words, the light panels are coded with a constant address in a fixed direction. When the light panels are connected in random orders or random directions, a system within the light panels won't be able to automatically adjust to the new configuration. As a result, the light panels may experience asynchronous light pattern failures, or even may experience light signal delivery failures.

### SUMMARY OF THE INVENTION

The present invention provides a multi-angle attachable display device and system thereof. A multi-angle attachable display device of the present invention includes a control module and a light emitting module.

The light emitting module is polygonal, and the light emitting module includes a light emitting layer, a light isolation layer, a cover layer, and a positioning layer.

The light emitting layer has a first surface, a second surface, and multiple side surfaces. The first surface is opposite to the second surface, and an amount of the side surfaces corresponds to an amount of sides for the polygonal light emitting module. The light emitting layer also includes at least one light emitting unit, a module driver and multiple connection ports. The at least one light emitting unit is mounted on the first surface of the light emitting layer, and the at least one light emitting unit has a unit driver. The module driver is electrically connected to the unit driver of the at least one light emitting unit. Each of the connection ports is mounted on one of the side surfaces of the light emitting layer, and each of the connection ports is electrically connected to the module driver.

The light isolation layer is mounted on the first surface of the light emitting layer, and the light isolation layer includes a light grate. The light grate consists of at least one cell to isolate the at least one light emitting unit.

The cover layer is mounted on the light grate of the light isolation layer facing away from the first surface. The positioning layer is mounted on the second surface of the light emitting layer. The positioning layer includes multiple grooves and a surface mounting unit. The grooves are placed on the positioning layer corresponding to positions of the connection ports of the light emitting layer.

The control module includes a controller connection port, a wireless communication unit, and a processing unit. The processing unit is electrically connected to the controller connection port and the wireless communication unit.

When the controller connection port is connected to one of the connection ports of the light emitting layer, the processing unit detects a connection pathway of the light emitting module, and the processing unit then controls the at least one light emitting unit of the light emitting module through the controller connection port and through the module driver with a light pattern signal generated by the processing unit.

A multi-angle attachable video system of the present invention includes a control module, a first light emitting module, and a second light emitting module.

The control module includes a controller connection port, a wireless communication unit, and a processing unit. The processing unit is electrically connected to the controller connection port and the wireless communication unit.

The first light emitting module is polygonal, and the light emitting module includes a light emitting layer, a light grate, and a cover layer.

The light emitting layer has a first surface and multiple side surfaces. An amount of the side surfaces corresponds to an amount of sides for the polygonal light emitting module. The light emitting layer also includes at least one light emitting unit, a module driver, and multiple connection ports. The at least one light emitting unit is mounted on the first surface of the light emitting layer, and the at least one light emitting unit has a unit driver. The module driver is electrically connected to the unit driver of the at least one light emitting unit. Each of the connection ports is mounted on a respective one of the side surfaces of the light emitting layer, and each of the connection ports is electrically connected to the module driver.

The light grate is mounted on the first surface of the light emitting layer. The light grate consists of at least one cell to isolate the at least one light emitting unit.

The cover layer is mounted on the light grate facing away from the first surface of the light emitting layer.

The second light emitting module is identical to the first light emitting module.

When the controller connection port is connected to one of the connection ports of the first light emitting module, and when the first light emitting module is connected to the second light emitting module through another one of the connection ports of the first light emitting module, the processing unit sends out a detection signal from the controller connection port to detect a connection pathway. The detection signal travels through the first light emitting module to the second light emitting module and returns back to the control module. After detecting the connection pathway, the processing unit then controls the at least one light emitting unit of both the first light emitting module and the second light emitting module through the controller connection port with a light pattern signal generated by the processing unit.

The present invention is able to acknowledge relative positions of the light emitting modules through a detection of the connection pathway by the detection signal. The light emitting modules therefore are able to freely connect with each other, forming a screen of arbitrary shape controlled by the processing unit. The processing unit is able to accept a video file via the wireless communication unit and to generate the light pattern signal. The module driver is able to receive the light pattern signal and correspondingly display the video file in different colored pixels.

### BRIEF DESCRIPTION OF THE DRAWINGS

FIG. 1 is a perspective view of a multi-angle attachable display device of the present invention.

FIG. 2 is an exploded view of the multi-angle attachable display device of the present invention.

FIG. 3A is a block diagram of a control module of the present invention.

FIG. 3B is a block diagram of a light emitting module of the present invention.

FIGS. 4A to 4C are perspective views of a positioning layer of the present invention.

FIG. 5 is a perspective view of a multi-angle attachable video system of the present invention.

FIG. 6 is another perspective view of the multi-angle attachable video system of the present invention.

FIG. 7 is another perspective view of the multi-angle attachable video system of the present invention.

FIG. 8 is a flow chart of how the present invention detects a connection pathway.

FIG. 9 is another flow chart of how the present invention detects the connection pathway.

### DETAILED DESCRIPTION OF THE INVENTION

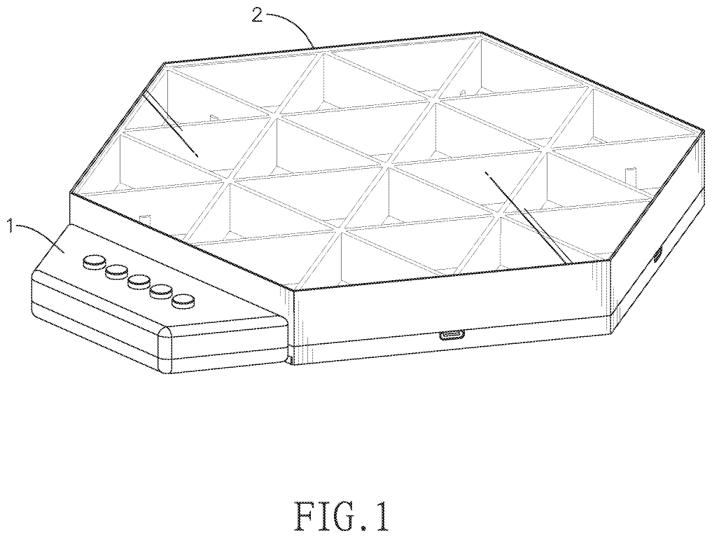

With reference to FIG. 1, the present invention provides a multi-angle attachable display device. The multi-angle attachable display device includes a control module 1 and a light emitting module 2.

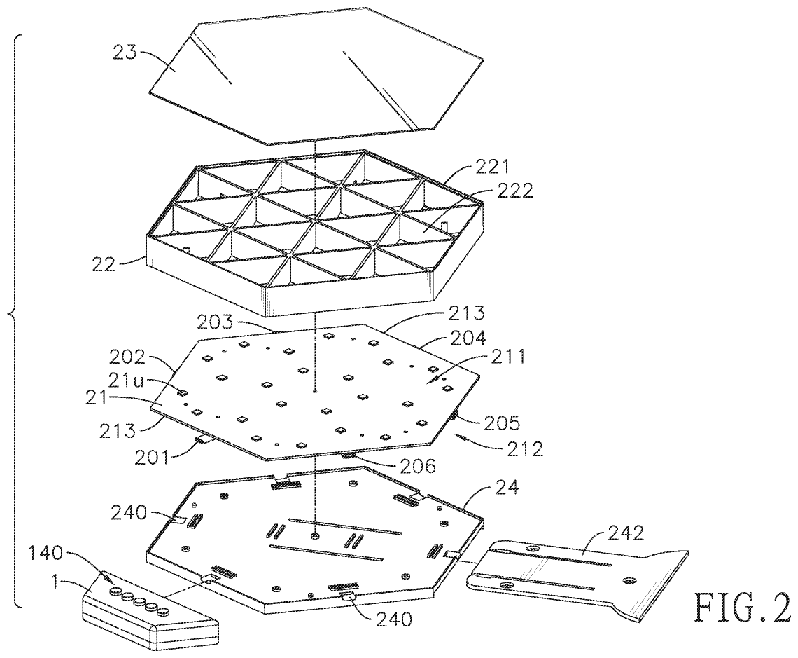

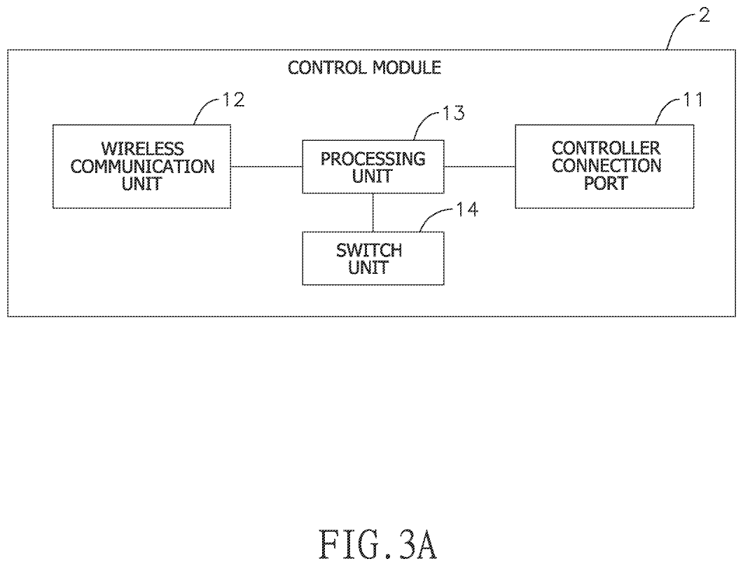

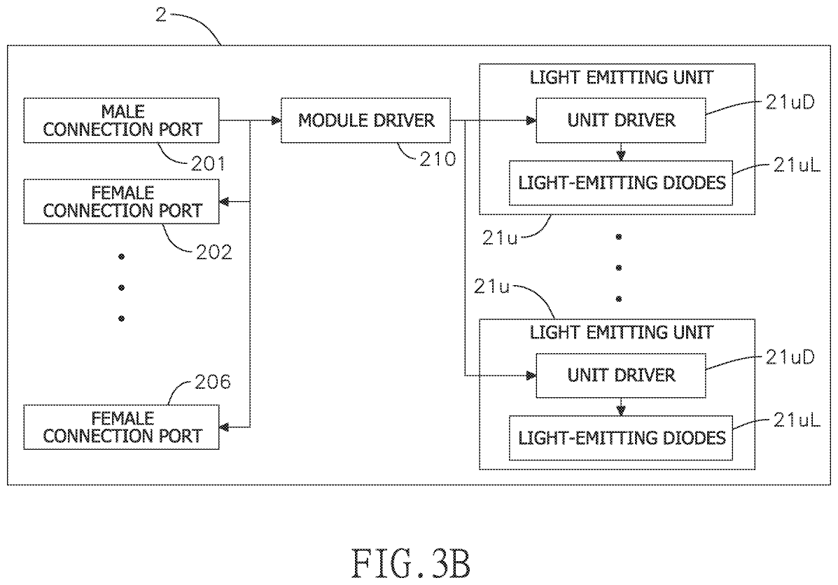

With reference to FIGS. 2 to 3B, the light emitting module 2 is polygonal, and the light emitting module 2 includes a light emitting layer 21, a light isolation layer 22, a cover layer 23, and a positioning layer 24.

The light emitting layer 21 has a first surface 211, a second surface 212, and multiple side surfaces 213. The first surface 211 is opposite to the second surface 212, and an amount of the side surfaces 213 corresponds to an amount of sides for the polygonal light emitting module 2.

The light emitting layer 21 also includes at least one light emitting unit 21u, a module driver 210, and multiple connection ports 201, 202, 203, 204, 205, 206. The at least one light emitting unit 21u is mounted on the first surface 211 of the light emitting layer 21. The at least one light emitting unit 21u has a unit driver 21uD. The module driver 210 is electrically connected to the unit driver 21uD of the at least one light emitting unit 21u. Each of the connection ports 201, 202, 203, 204, 205, 206 is mounted on a respective one of the side surfaces 213 of the light emitting layer 21.

In an embodiment of the present invention, the at least one light emitting unit 21u also includes light-emitting diodes (LEDs) 21uL. The LEDs 21uL are capable of displaying different colors. The unit driver 21uD is electrically connecting to the LEDs 21uL for driving the LEDs 21uL in the at least one light emitting unit 21u. Each of the connection ports 201, 202, 203, 204, 205, 206 is electrically connected to the module driver 210.

The light isolation layer 22 is mounted on the first surface 211 of the light emitting layer 21, and the light isolation layer 22 includes a light grate 221. The light grate 221 includes at least one cell 222 to isolate the at least one light emitting unit 21u.

The cover layer 23 is mounted on the light grate 221 of the light isolation layer 22 facing away from the first surface 211. The positioning layer 24 is mounted on the second surface 212 of the light emitting layer 21. The positioning layer 24 includes multiple grooves 240 and a surface mounting unit 242. The grooves 240 are formed on the positioning layer 24 aligned to positions of the connection ports 201, 202, 203, 204, 205, 206 of the light emitting layer 21.

The control module 1 includes a controller connection port 11, a wireless communication unit 12, and a processing unit 13. The processing unit 13 is electrically connected to the controller connection port 11 and the wireless communication unit 12.

When the controller connection port 11 is connected to one of the connection ports 201, 202, 203, 204, 205, 206 of the light emitting layer 21, the processing unit 13 detects a connection pathway of the light emitting module 2, and the processing unit 13 then controls the at least one light emitting unit 21u of the light emitting module 21 through the controller connection port 11 and through the module driver 210 with a light pattern signal generated by the processing unit 13.

In the present embodiment, the multi-angle attachable display device is in the shape of a hexagon. This means the light emitting layer 21, the light isolation layer 22, the cover layer 23, and the positioning layer 24 are all hexagons. The amount of sides for the polygonal light emitting module 2 is therefore six, and the amount of the side surfaces for the light emitting layer 21 is also six.

The controller connection port 11 is a female connection port, and the connection ports 201, 202, 203, 204, 205, 206 of the light emitting layer 21 of the light emitting module 2 include a male connection port 201 and multiple female connection ports 202, 203, 204, 205, 206. More particularly, the light emitting layer 21 of the light emitting module 2 has the male connection port as a first port 201 and subsequently clockwise has the female connection ports as a second port 202, a third port 203, a fourth port 204, a fifth port 205, and a sixth port 206.

When a detection signal generated by the processing unit 13 detects whether any one of the female connection ports 202, 203, 204, 205, 206 is connected, the detection signal travels from the second port 202 subsequently to the sixth port 206 before returning back to the processing unit 13 of the control module 1.

With reference to FIG. 3B, in this embodiment, the light pattern signal enters the light emitting module 2 through the male connection port 201 and the light pattern signal is received by the module driver 210 in the light emitting module 2. The module driver 210 further controls the at least one light emitting unit 21u by sending the light pattern signal to the unit driver 21uD of the at least one light emitting unit 21u. The unit driver 21uD drives the LEDs 21uL displaying colors according to the light pattern signal. When any one of the female connection ports 202, 203, 204, 205, 206 is connected, the module driver 210 further sends the light pattern signal out of any one of the connected female connection ports 202, 203, 204, 205, 206.

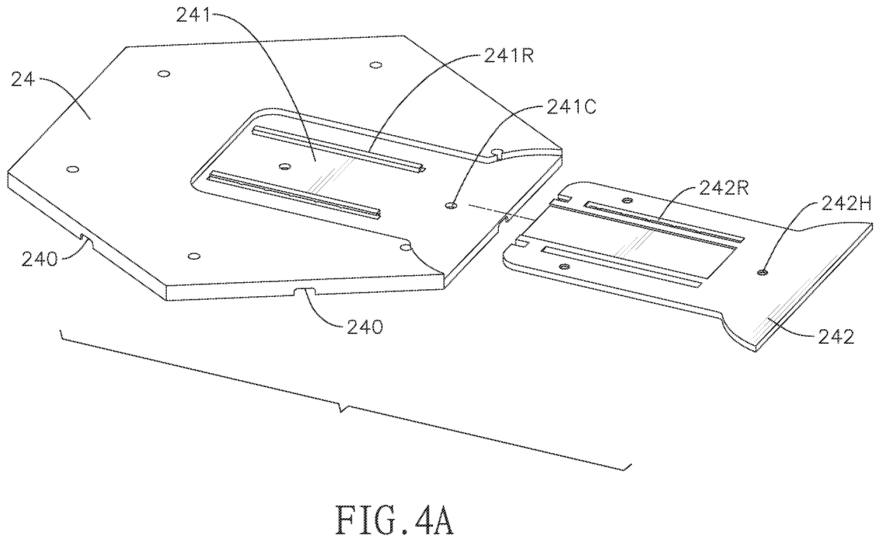

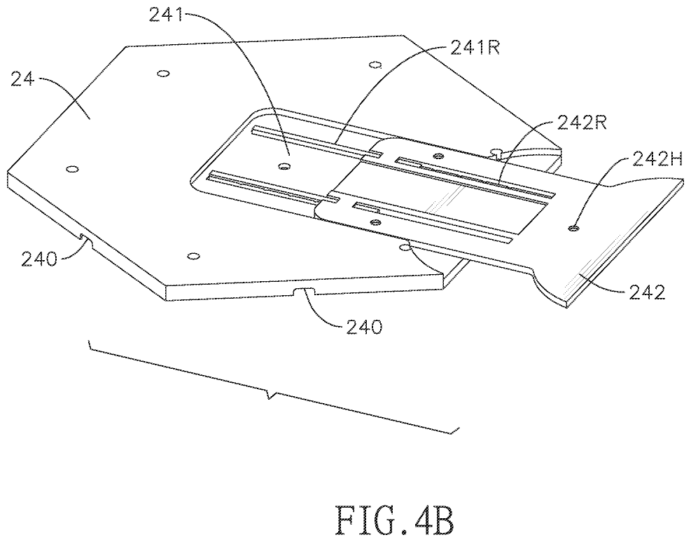

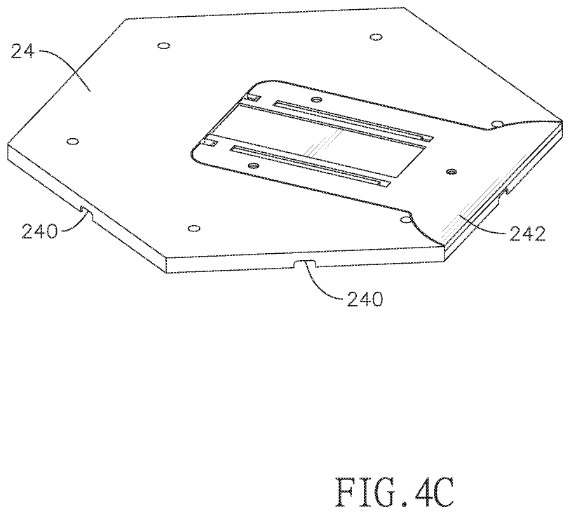

With reference to FIGS. 4A to 4C, the positioning layer 24 further includes a slot 241. The surface mounting unit 242 is detachable from the positioning layer 24 by sliding out of the slot 241, and the surface mounting unit 242 is attachable to the positioning layer 24 by sliding back into the slot 241. The surface mounting unit 242 is mountable to a surface, and by attaching the surface mounting unit 242 to the slot 241 of the positioning layer 24, the light emitting module 2 as a whole is also mountable to the surface.

In the present embodiment, the slot 241 further includes a rail guide 241R, and the surface mounting unit 242 further includes a rail 242R. The rail guide 241R and the rail 242R correspond to each other. FIG. 4A depicts when the surface mounting unit 242 is about to slide into the slot, the rail guide 241R and the rail 242R should be aligned with each other. FIG. 4B depicts the rail guide 241R on the slot 241 catches the rail 242R of the surface mounting unit 242, allowing the surface mounting unit 242 to slide into the slot 241. FIG. 4C depicts once the slot 241 and the surface mounting unit 242 are recombined, the slot 241 and the surface mounting unit 242 are re-attached to each other.

In the present embodiment, the re-attachment of the slot 241 and the surface mounting unit 242 is aided by gravity, as the light emitting unit 2 is oriented such that gravitational force pushes the slot 241 down onto the surface mounting unit 242, and the surface mounting unit 242 catches weight of the slot 241 as well as weight of the rest of the light emitting unit 2. In another embodiment, the slot 241 further includes a catch 241C, and the surface mounting unit 242 further includes a hole 242H. When the surface mounting unit 242 slides into the slot 241, the catch 241C of the slot 241 catches the hole 242H, aiding the re-attachment of the slot 241 and the surface mounting unit 242.

The wireless communication unit 12 of the control module 1 connects to a wireless network. Through the wireless communication unit 12, the processing unit 13 connects to an external device through the wireless network for obtaining a video file. The processing unit 13 then generates the light pattern signal according to the video file.

The at least one cell 222 is in an identical shape and divides a surface area of the light emitting layer 21 equally. In the present embodiment, the at least one cell 222 is triangularly shaped, and divides the hexagonal surface area of the light emitting layer 21. There are a total of twenty four light emitting units 21u mounted on the light emitting layer 21, and twenty four cells 222 on the light grate 221 isolating each of the at least one light emitting unit 21u. Each of the at least one cell 222 has a respective one of the at least one light emitting unit 21u disposed in a center of the at least one cell 222.

The control module 1 further includes a switch unit 14. The switch unit 14 is electrically connected to the processing unit 13. When the switch unit 14 is pressed, the switch unit 14 generates a light changing signal to the processing unit 13. The processing unit 13 receives the light changing signal and changes the light pattern signal delivered to the module driver 210. As a result, the light pattern of the at least one light emitting unit 21u accordingly changes. In the present embodiment, the switch unit 14 includes five switches 140, and each of the five switches 140 corresponds to a unique light pattern. When any of the five switches 140 is pressed, the light changing signal is generated for switching the light pattern of the light emitting units 21u.

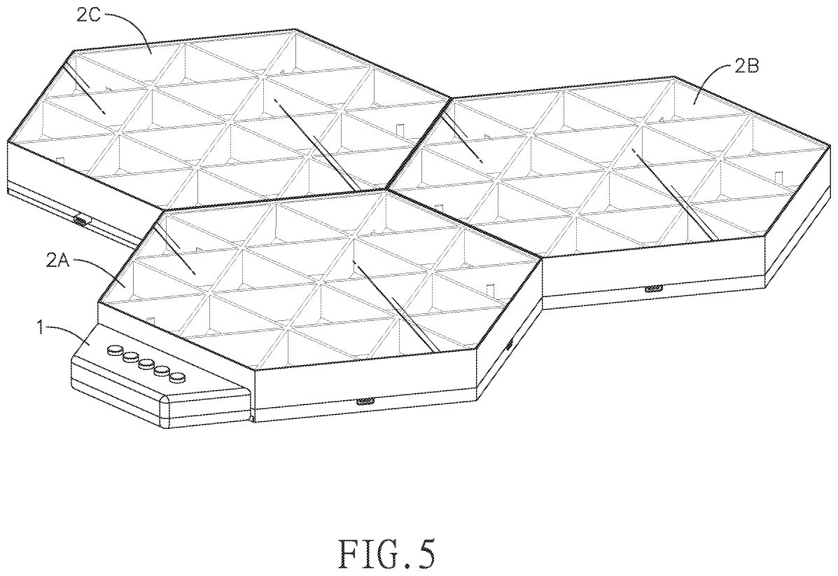

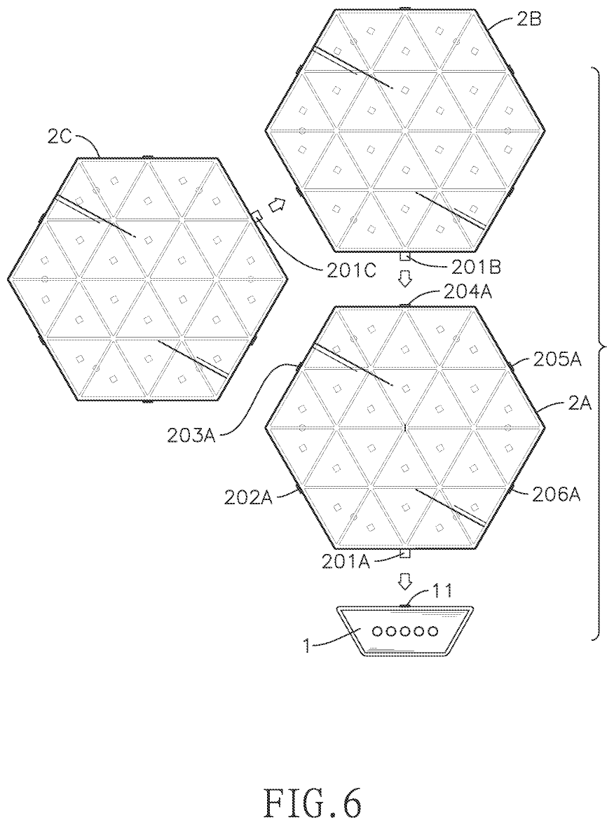

With further reference to FIGS. 5 and 6, a multi-angle attachable video system of the present invention includes the control module 1 and multiple light emitting modules. The multiple light emitting modules at least include a first light emitting module 2A and a second light emitting module 2B.

The first light emitting module 2A and the second light emitting module 2B are identical to the light emitting module 2. In the present embodiment, the controller connection port 11 is a female connection port. The connection ports 201A, 202A, 203A, 204A, 205A, 206A of the first light emitting module 2A comprise a male connection port 201A and multiple female connection ports 202A, 203A, 204A, 205A, 206A. The second light emitting module 2B is identical to the first light emitting module 2A. The first light emitting module 2A includes the first port 201A, and the second port 202A, the third port 203A, the fourth port 204A, the fifth port 205A, and the sixth port 206A of the opposite gender. With similar logic, the second light emitting module 2B includes the first port 201B as the male connection port.

When the controller connection port 11 is connected to the first port 201A of the first light emitting module 2A, and when one of the female connection ports 202A, 203A, 204A, 205A, 206A of the first light emitting module 2A is connected to the first port 201B of the second light emitting module 2B, the processing unit 13 sends out the detection signal from the controller connection port 11 to detect the connection pathway. The detection signal travels through the first light emitting module 2A from the first port 201A, and further travels to the second light emitting module 2B from the first port 201B. The detection signal then returns back to the control module 1. After detecting the connection pathway, the control module 1 then controls the at least one light emitting unit 21u of both the first light emitting module 2A and the second light emitting module 2B through the controller connection port 11 with a light pattern signal generated by the processing unit 13.

The wireless communication unit 12 connects to the wireless network. Through the wireless communication unit 12, the processing unit 13 connects to an external device through the wireless network for obtaining a video file. The processing unit 13 then generates the light pattern signal according to the video file.

When the first port 201A of the first light emitting module 2A connects the controller connection port 11, the processing unit 13 sends the detection signal to the module driver 210 of the first light emitting module 2A. The module driver 210 detects whether any one of the female connection ports 202A, 203A, 204A, 205A, 206A of the first light emitting module 2A is connected to the first port 201B of the second light emitting module 2B.

When any one of the female connection ports 202A, 203A, 204A, 205A, 206A of the first light emitting module 2A is connected to the first port 201B of the second light emitting module 2B, the module driver 210 of the first light emitting module 2A sends the detection signal further to the second light emitting module 2B.

When none of the female connection ports 202A, 203A, 204A, 205A, 206A of the first light emitting module 2A is connected to the first port 201B of the second light emitting module 2B, the module driver 210 of the first light emitting module 2A sends the detection signal back to the processing unit 13 through the first port 201A.

When the second light emitting module 2B receives the detection signal, the second light emitting module 2B follows the same logic as the first light emitting module 2A. In other words, when none of the female connection ports of the second light emitting module 2B is connected to any other light emitting modules, the second light emitting module 2B sends the detection signal back to the first light emitting module 2A through the first port 201B.

Once the detection signal returns back to the processing unit 13, the connection pathway is generated by the processing unit 13 as the pathway the detection signal travels.

In another embodiment, the multiple light emitting modules further include a third light emitting module 2C. The third light emitting module 2C is also identical to the light emitting module 2. Both the first light emitting module 2A, the second light emitting module 2B, and the third light emitting module 2C are hexagons. The third light emitting module 2C includes the first port 201C as the male connection port.

When any one of the female connection ports of the second light emitting module 2B is connected to the first port 201C of the third light emitting module 2C, the second light emitting module 2B sends the detection signal through the first port 201C to the third light emitting module 2C.

When none of the female connection ports of the third light emitting module 2C is connected to any more light emitting modules, the detection signal travels from the second port of the third light emitting module 2C subsequently to the sixth port of the third light emitting module 2C before returning back to the second light emitting module 2B through the first port 201C. Once the detection signal returns to the second light emitting module 2B, the detection signal further travels subsequently to the sixth port of the second light emitting module 2B before returning back to the first light emitting module 2A through the first port 201B.

Once the detection signal returns to the first light emitting module 2A, the detection signal further travels subsequently to the sixth port 206A of the first light emitting module 2A before returning back to the processing unit 13 through the first port 201A.

In other words, when the first port 201A of the first light emitting module 2A is connected to the controller connection port 11, the first port 201B of the second light emitting module 2B is connected to the fourth port 204A of the first light emitting module 2A, and the first port 201C of the third light emitting module 2C is connected to the second port of the second light emitting module 2B, the detection signal travels as follows:

From the processing unit 13 to the controller connection port 11.

From the first port 201A of the first light emitting module 2A clockwise to the fourth port 204A of the first light emitting module 2A.

From the first port 201B of the second light emitting module 2B clockwise to the second port of the second light emitting module 2B.

From the first port 201C of the third light emitting module 2C clockwise all the way back to the first port 201C of the third light emitting module 2C.

From the second port of the second light emitting module 2B clockwise all the way back to the first port 201B of the second light emitting module 2B.

From the fourth port 204A of the first light emitting module 2A clockwise all the way back to the first port 201A of the first light emitting module 2A, and then through the controller connection port 11 back to the processing unit 13.

In this case, since a distance from the first light emitting module 2A to the third light emitting module 2C is longer than a distance to the second light emitting module 2B, the processing unit 13 would adjust the synchronization condition for delivering the light pattern signal to both the second and third light emitting modules 2B, 2C, ensuring a screen made up by the first, second, and third light emitting modules 2A, 2B, 2C simultaneously work together to display the video file.

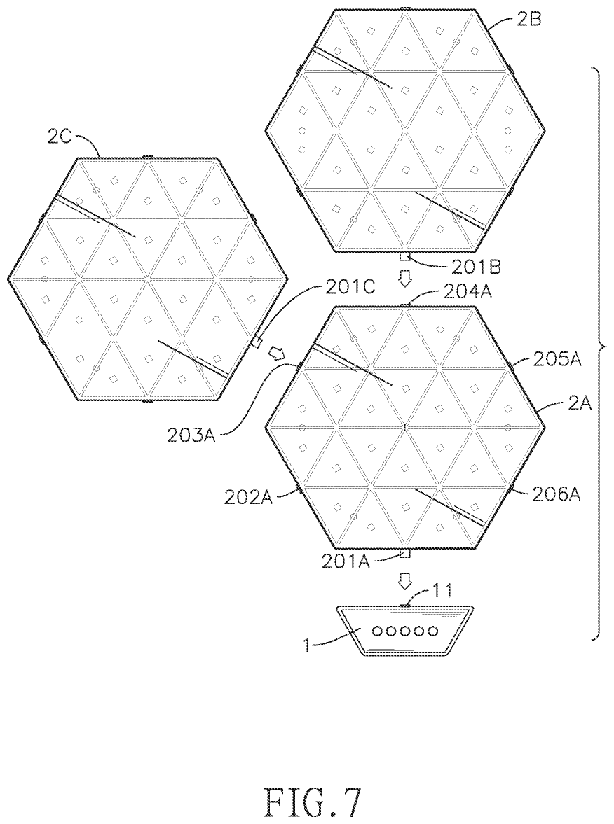

With reference to FIG. 7, in another example, when the first port 201A of the first light emitting module 2A is connected to the controller connection port 11, the first port 201C of the third light emitting module 2C is connected to the third port 203A of the first light emitting module 2A, and the first port 201B of the second light emitting module 2B is connected to the fourth port 204A of the first light emitting module 2A, the detection signal travels as follows:

From the processing unit 13 to the controller connection port 11.

From the first port 201A of the first light emitting module 2A clockwise to the third port 203A of the first light emitting module 2A.

From the first port 201C of the third light emitting module 2C clockwise all the way back to the first port 201C of the third light emitting module 2C.

From the third port 203A of the first light emitting module 2A clockwise all the way back to the first port 201A of the first light emitting module 2A, ignoring the second light emitting module 2B, and then through the controller connection port 11 back to the processing unit 13.

The detection signal ignores the second light emitting module 2B since after the detection signal returns back from the third light emitting module 2C, the detection signal already changes address to stop seeking more new connections of light emitting modules. In other words, once the detection signal travels from the first port 201C of the third light emitting module 2C clockwise all the way back to the first port 201C of the third light emitting module 2C, the detection signal changes its address to a return mode to return back to the processing unit 13.

In another embodiment, once the detection signal travels from the first port 201C of the third light emitting module 2C clockwise all the way back to the first port 201C of the third light emitting module 2C, the detection signal still seeks new possible connections of more light emitting modules. In this case, the detection signal travels as follows:

From the first port 201C of the third light emitting module 2C clockwise all the way back to the first port 201C of the third light emitting module 2C.

From the third port 203A of the first light emitting module 2A to the fourth port 204A of the first light emitting module 2A.

From the first port 201B of the second light emitting module 2B clockwise all the way back to the first port 201B of the second light emitting module 2B.

From the fourth port 204A of the first light emitting module 2A clockwise all the way back to the first port 201A of the first light emitting module 2A, and then through the controller connection port 11 back to the processing unit 13.

In this case, since the distance from the first light emitting module 2A to the third light emitting module 2C is the same as the distance to the second light emitting module 2B, the processing unit 13 would adjust the synchronization condition for delivering the light pattern signal to both the second and third light emitting modules 2B, 2C, ensuring the screen displays the video file in synchronization. The processing unit 13 uses conventional ways of achieving synchronization between all the light emitting modules 2 after the connection pathway is obtained.

In all embodiments described above, despite having different types of connection pathways, the first, second, and third light emitting modules 2A, 2B, 2C are able to attach to each other without leaving any gaps in between. Together, the first, second, and third light emitting modules 2A, 2B, 2C form the screen capable of displaying the video received by the control module 1.

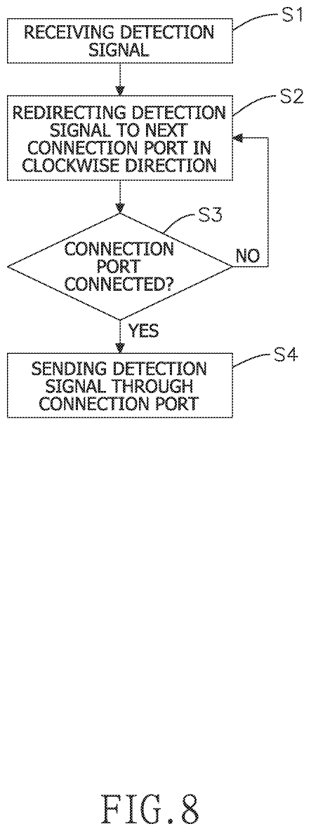

With reference to FIG. 8, the processing unit 13 uses the detection signal to detect the connection pathway. The detection signal is sent from the processing unit 13 and further navigated by the module driver 210. As such, the module driver 210 of the first light emitting module 2A executes the following steps:

Step S1: receiving the detection signal; in other words, the module driver 210 first receives the detection signal from the processing unit 13 through the first port 201A.

Step S2: redirecting the detection signal to the next connection port in a clockwise direction. In other words, the module driver 210 receives the detection signal from the first port 201A, and sends the detection signal towards the next connection port in a clockwise direction with respect to the first port 201A, in the order of the second port 202A, the third port 203A, the fourth port 204A, etc.

Step S3: determining whether the next connection port is connected; when the next connection port is determined to be disconnected, returning to step S2. In other words, if the next connection port is the second port 202A, the module driver 210 determines whether the second port 202A is connected. When the second port 202A is disconnected, the module driver 210 travels to the third port 203A.

Step S4: when the next connection port is determined to be connected, sending the detection signal through the next connection port. In other words, if the next connection port is the second port 202A, and the module driver 210 determines the second port 202A is connected to the first port 201B of the second light emitting module 2B, then the module driver 210 sends the detection signal to the second light emitting module 2B.

Once the detection signal enters the second light emitting module 2B, the module driver of the second light emitting module 2B follows the same steps S1 to S4 described above. When the module driver of the second light emitting module 2B executes step S4 and discovers that the next connection port is the first port 201B and is determined to be connected, this means the detection signal is going to start returning all the way back to the processing unit 13.

Once the module driver 210 of the first light emitting module 2A receives the returned detection signal from the second light emitting module 2B, the module driver 210 of the first light emitting module 2A again executes steps S1 to S4. By the time the first light emitting module 2A executes step S4 again, the first light emitting module 2A should send the detection signal back to the processing unit 13.

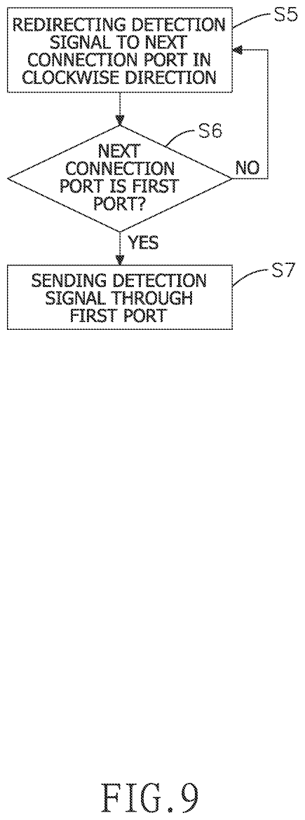

With reference to FIG. 9, in another embodiment, after the module driver 210 of the first light emitting module 2A receives the returned detection signal from the second light emitting module 2B, the module driver 210 ofthe first light emitting module 2A further executes the following steps:

Step S5: redirecting the detection signal to the next connection port in a clockwise direction.

Step S6: determining whether the next connection port is the first port 201A; when the next connection port is determined yet to be the first port 201A, returning to step S5.

In other words, if the next connection port is yet to be the first port 201A, then continue redirecting the detection signal until the detection signal reaches the first port 201A. This situation is similarly depicted previously in FIG. 7, wherein in one of the embodiments described, the returned detection signal would ignore traveling to the second light emitting module 2B after the detection signal returns back to the first light emitting module 2A from the third light emitting module 2C.

Step S8: when the next connection port is determined to be the first port 201A, sending the detection signal to exit through the first port 201A. In other words, directing the detection signal to return back to the processing unit 13.

Once the detection signal returns back to the processing unit 13, the processing unit 13 is able to detect the connection pathway by generating the connection pathway according to the route the detection signal traveled and navigated by the module driver 210. The connection pathway is as a loop around the present invention, with the first light emitting module 2A and the second light emitting module 2B connected in series. The processing unit 13 then generates the light pattern signal according to the connection pathway, ensures the video is properly displayed on the screen formed by the first light emitting module 2A and the second light emitting module 2B, and avoids signal delivery failures.

The present invention allows arbitrary connections of the first light emitting module 2A and the second light emitting module 2B, allowing the screen made up by the first light emitting module 2A and the second light emitting module 2B to be arbitrarily shaped. More particularly, the first port 201B of the second light emitting module 2B can arbitrarily connect to the female connection ports 202A, 203A, 204A, 205A, 206A of the first light emitting module 2A. As long as each angle of both the first light emitting module 2A and the second light emitting module 2B is divisible by 360 degrees, the first light emitting module 2A and the second light emitting module 2B would attach to each other without leaving any gaps in between. For instance, when the first light emitting module 2A and the second light emitting module 2B are hexagons as previously mentioned, and when each angle of the hexagons is 120 degrees, then the first light emitting module 2A and the second light emitting module 2B would attach to each other without leaving any gaps in between as 360 degrees is divisible by 120 degrees. For this same reason, in other embodiments of the present invention, the light emitting module 2 can be a rectangle, an equivalent triangle, or a 90-60-30 degrees triangle.

The aforementioned arbitrary connections are within limits that a male connection port can only connect to a female connection port and vise versa. In other embodiments, genders of the connection ports in the present embodiment may be opposite. In that case, similar logic regarding the aforementioned arbitrary connections still applies. After the first light emitting module 2A and the second light emitting module 2B are arbitrarily connected, the control module 1 of the present invention is able to deliver the light changing signal without failures as the connection pathway is mapped. To ensure the connection pathway remains correct, the processing unit 13 may periodically send out the detection signal to map out and to update the connection pathway again. Once the connection pathway is mapped, the present invention then is able to adjust synchronization strategy for the first light emitting module 2A and the second light emitting module 2B so that the video file is successfully played on the screen. The module driver 210 of the light emitting module 2 is able to receive the light changing signal from the processing unit 13 and accordingly controls the unit driver 21uD of the at least one light emitting unit 21u to adjust colors of the LEDs 21uL independently. This way the LEDs 21uL function as pixels of the screen.

What is claimed is:

1. A multi-angle attachable display device, comprising:
a light emitting module, being polygonal, and further comprising:
a light emitting layer, having a first surface, a second surface, and multiple side surfaces; wherein the first surface is opposite to the second surface, and an amount of the side surfaces corresponds to an amount of sides of the polygonal light emitting module; wherein the light emitting layer further comprises:
at least one light emitting unit, mounted on the first surface of the light emitting layer; wherein the at least one light emitting unit has a unit driver;
a module driver, electrically connected to the unit driver of the at least one light emitting unit; and
multiple connection ports; wherein each of the connection ports is mounted on a respective one of the side surfaces of the light emitting layer, and each of the connection ports is electrically connected to the module driver;
a light isolation layer, mounted on the first surface of the light emitting layer, and comprising a light grate; wherein the light grate consists of at least one cell to isolate the at least one light emitting unit;
a cover layer, mounted on the light grate of the light isolation layer facing away from the first surface; and
a positioning layer, mounted on the second surface of the light emitting layer, comprising multiple grooves and a surface mounting unit; wherein the grooves are disposed on the positioning layer corresponding to positions of the connection ports of the light emitting layer; and
a control module, further comprising:
a controller connection port;
a wireless communication unit; and
a processing unit, electrically connected to the controller connection port and the wireless communication unit;
wherein when the controller connection port is connected to one of the connection ports of the light emitting layer, the processing unit detects a connection pathway of the light emitting module, and the processing unit then controls the at least one light emitting unit of the light emitting module through the controller connection port and through the module driver with a light pattern signal generated by the processing unit.

2. The multi-angle attachable display device as claimed in claim 1, wherein:
the wireless communication unit connects to a wireless network;
through the wireless communication unit, the processing unit connects to an external device through the wireless network for obtaining a video file;
the processing unit generates the light pattern signal according to the video file.

3. The multi-angle attachable display device as claimed in claim 2, wherein:
the positioning layer further comprises a slot and a holder unit; the holder unit is detachable from the positioning layer by sliding out of the slot, and the holder is attachable to the positioning layer by sliding back into the slot;
the holder is mountable to a wall; and by attaching the holder to the positioning layer, the light emitting module as a whole is also mountable to the wall.

4. The multi-angle attachable display device as claimed in claim 2, wherein:
the controller connection port is a female connection port; and
the connection ports of the light emitting module comprise a male connection port and multiple female connection ports.

5. The multi-angle attachable display device as claimed in claim 4, wherein:
the light emitting module is a hexagon;
the light emitting module has the male connection port as a first port and subsequently in a clockwise direction has the female connection ports as a second port, a third port, a fourth port, a fifth port, and a sixth port;
when a detection signal generated by the processing unit detects whether any one of the female connection ports is connected, the detection signal travels from the second port subsequently to the sixth port before returning back to the processing unit.

6. The multi-angle attachable display device as claimed in claim 4, wherein:
the processing unit generates a detection signal to detect a connection pathway; the detection signal is sent from the processing unit and navigated by the module driver; the module driver executes steps as follows:
step A: receiving the detection signal;
step B: redirecting the detection signal to the next connection port in a clockwise direction counting clockwise from the male connection port;
step C: determining whether the next connection port is connected; when the next connection port is determined to be disconnected, returning to step B;
step D: when the next connection port is determined to be connected, sending the detection signal through the next connection port.

7. The multi-angle attachable display device as claimed in claim 2, wherein:
the at least one light emitting unit comprises the unit driver and light-emitting diodes (LEDs); the unit driver is electrically connecting to the LEDs for driving the LEDs in the at least one light emitting unit.

8. The multi-angle attachable display device as claimed in claim 2, wherein:
the at least one cell divides a surface area of the light emitting layer equally.

9. The multi-angle attachable display device as claimed in claim 2, wherein:
the control module comprises a switch unit; the switch unit is electrically connected to the processing unit;
when the switch unit is pressed, the switch unit generates a light changing signal to the processing unit; the processing unit receives the light changing signal and changes the light pattern signal, and the light pattern of the at least one light emitting unit accordingly changes.

10. The multi-angle attachable display device as claimed in claim 9, wherein:
the switch unit further comprises multiple switches;
when any of the switches is pressed, the light changing signal is generated for switching the light pattern of the at least one light emitting unit.

11. A multi-angle attachable video system, comprising:
a control module, further comprising:
a controller connection port;
a wireless communication unit; and
a processing unit, electrically connected to the controller connection port and the wireless communication unit;
a first light emitting module, being polygonal, and further comprising:
a light emitting layer, has a first surface and multiple side surfaces; wherein an amount of the side surfaces corresponds to an amount of sides of the polygonal light emitting module; wherein the light emitting layer further comprises:
at least one light emitting unit, mounted on the first surface of the light emitting layer; wherein the at least one light emitting unit has a unit driver;
a module driver, electrically connected to the unit driver of the at least one light emitting unit; and
multiple connection ports; wherein each of the connection ports is mounted on one of the side surfaces of the light emitting layer, and each of the connection ports is electrically connected to the module driver;
a light grate, mounted on the first surface of the light emitting layer; wherein the light grate consists of at least one cell to isolate the at least one light emitting unit; and
a cover layer, mounted on the light grate facing away from the first surface of the light emitting layer;
a second light emitting module, identical to the first light emitting module;
wherein when the controller connection port is connected to one of the connection ports of the first light emitting module, and when the first light emitting module is connected to the second light emitting module through another one of the connection ports of the first light emitting module, the processing unit sends out a detection signal from the controller connection port to detect a connection pathway;
wherein the detection signal travels through the first light emitting module to the second light emitting module and returns back to the control module;
wherein after detecting the connection pathway, the processing unit then controls the at least one light emitting unit of both the first light emitting module and the second light emitting module through the controller connection port with a light pattern signal generated by the processing unit.

12. The multi-angle attachable video system as claimed in claim 11, wherein:
the wireless communication unit connects to a wireless network;
through the wireless communication unit, the processing unit connects to an external device through the wireless network for obtaining a video file;
the processing unit generates the light pattern signal according to the video file.

13. The multi-angle attachable video system as claimed in claim 12, wherein:
the controller connection port is a female connection port;
the connection ports of the first light emitting module comprise a male connection port and multiple female connection ports; and
the second light emitting module is identical to the first light emitting module.

14. The multi-angle attachable video system as claimed in claim 13, wherein:
when the male connection port of the first light emitting module connects the controller connection port, the processing unit sends the detection signal to the module driver of the first light emitting module, and the module driver detects whether any of the female connection ports of the first light emitting module is connected to the male connection port of the second light emitting module;
when any one of the female connection ports of the first light emitting module is connected to the male connection port of the second light emitting module, the module driver of the first light emitting module sends the detection signal to the second light emitting module;
when none of the female connection ports of the first light emitting module is connected to the male connection port of the second light emitting module, the module driver of the first light emitting module sends the detection signal back to the processing unit;
the processing unit generates the connection pathway as a pathway the detection signal traveled.

15. The multi-angle attachable video system as claimed in claim 12, wherein:
both the first light emitting module and the second light emitting module are hexagons;
both the first light emitting module and the second light emitting module respectively have the male connection port as a first port and subsequently in a clockwise direction the female connection ports as a second port, a third port, a fourth port, a fifth port, and a sixth port;
when the detection signal detects whether any one of the female connection ports is connected, the detection signal travels from the second port subsequently to the sixth port before returning back to the processing unit.

16. The multi-angle attachable video system as claimed in claim 12, wherein:
the at least one light emitting unit comprises the unit driver and light-emitting diodes (LEDs); the unit driver is electrically connecting to the LEDs for driving the LEDs in the at least one light emitting unit.

17. The multi-angle attachable video system as claimed in claim 12, wherein:
the at least one cell divides a surface area of the light emitting layer equally.

18. The multi-angle attachable video system as claimed in claim 12, wherein:
the control module comprises a switch unit; the switch unit is electrically connected to the processing unit;
when the switch unit is pressed, the switch unit generates a light changing signal to the processing unit; the processing unit receives the light changing signal and changes the light pattern signal, and the light pattern of the light emitting units accordingly changes.

19. The multi-angle attachable display device as claimed in claim 18, wherein:
the switch unit further comprises multiple switches;
when any of the switches is pressed, the light changing signal is generated for switching the light pattern of the light emitting units.
